(19) United States
(12) Patent Application Publication
(10) Pub. No.: US 2026/0313539 A1
(43) Pub. Date: Oct. 8, 2026

(54) METHOD AND DEVICE FOR HANDLING DISCONTINUOUS RECEPTION, UPLINK, AND RANDOM ACCESS ADAPTION

(71) Applicant: Samsung Electronics Co., Ltd., Gyeonggi-do (KR)

(72) Inventors: Aby Kanneath ABRAHAM, Bangalore (IN); Sangyeob JUNG, Gyeonggi-do (KR)

(21) Appl. No.: 18/880,752

(22) PCT Filed: Jun. 30, 2023
(86) PCT No.: PCT/KR2023/009255

§ 371 Date: Jan. 2, 2025

(30) Foreign Application Priority Data
Jul. 1, 2022 (IN) 202241038128
Jun. 5, 2023 (IN) 202241038128

(51) Int. Cl. H04W 52/02

(52) U.S. Cl. CPC H04W 52/0216; H04W 52/0235

(57) ABSTRACT

A method performed by a UE in a wireless communication system supporting MUSIM operations is disclosed. The method includes receiving, from a base station, DRX configuration information, configuration information on DCP occasion, and MUSIM gap configuration information. The DRX configuration information includes the DRX cycle information. The configuration information on the DCP occasion includes timing intervals for wakeup indication. The MUSIM gap configuration information includes timing intervals for the MUSIM operations. The method also includes determining whether the timing intervals for wakeup indication associated with a current DRX cycle overlaps with at least one of the timing interval for the MUSIM operations. Further, the method includes starting a DRX-ON duration timer after the at least one of the timing interval for the MUSIM operations has lapsed upon in case that the one or more timing intervals for wakeup indication associated with the current DRX cycle overlap with at least one of the timing interval for the MUSIM operations.

### TECHNICAL FIELD

The present disclosure generally relates to wireless communication, and more specifically related to methods and devices for handling Discontinuous Reception (DRX) adaptation, Uplink (UL) operations, and Random Access (RA) adaptation during Multiple Subscriber Identity Module (MUSIM) operations.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In wireless technologies like New Radio (NR) and Long-Term Evolution (LTE), a Radio Resource Control (RRC) connected User Equipment (UE) performs various measurements for Radio Resource Measurement (RRM) purposes, positioning, etc. In some instances, the network configures one or more measurement gaps to instruct the UE to suspend any transmission or reception during the gap period as defined by such measurement gaps. The network defines measurement gap configuration which includes a gap offset, a gap length, a repetition period, and a measurement gap timing advance. In NR release 17, the Third Generation Partnership Project (3GPP) introduced gaps for other purposes than measurements. For instance, gaps were introduced for self-calibration and monitoring, specifically for Frequency Range 2 (FR2 ) frequencies, and are known as FR2 Uplink (UL) gaps. Further, operations like Random Access (RA) are prioritized over FR2 UL gaps. Another type of gap that was introduced by 3GPP in release 17 is for Multi Subscriber Identity Module (MUSIM) operations and is known as the MUSIM gap.

Conventionally, MUSIM UEs operated by creating arbitrary MUSIM gaps without any network control. Thereafter, 3GPP decided to introduce MUSIM gaps to support MUSIM operations at the MUSIM UEs in Release 17. From Release 17, a connected Universal SIM (USIM) in a MUSIM device can notify the connected network about network switching for multi-SIM operations.

Further, there are two typed of network switching supported for MUSIM operations. In one type, a connected USIM leaves a connected network and completely switches to the other USIM, i.e. other USIM becomes connected. In other type, the connected USIM request for a gap from the connected network network for the MUSIM operations like listening for paging or performing measurements in the idle USIM. In release 17, MUSIM UE uses RRC UE Assistance Information (UAI) procedure to request gNB for gaps or to notify the network about leaving. The network configures the UE whether the network can provide the assistance information for MUSIM gaps or MUSIM Leave using otherConfig in RRC messages. Musim-GapAssistanceConfig in otherConfig is used for informing the UE whether the network can provide MUSIM assistance information for providing gap information. On request from the UE, the network may allocate MUSIM gaps to the UE.

Moreover, in NR Release 16, various power saving techniques such as Discontinuous Reception (DRX) adaptation power saving technique, enhanced DRX (eDRX), Power Saving Mode (PSM), etc., were introduced. Specifically, the network configures some of the active Bandwidth Parts (BWP) with power saving signals. Before DRX is ON, the UE is configured to monitor an indication to decide whether to wake-up or not. Further, NR Downlink Control Information (DCI) with Cyclic Redundancy Check (CRC) scrambled by Power Saving-Radio Network Temporary Identifier (PS-RNTI) (DCP) occasions are used for such wakeup indication. Generally, the network is allowed to configure a PS-offset semi-statically before DRX ON to define the start of the interval for the DCP occasion. Further, the DCP occasion may vary for different network scenarios such as Carrier Aggregation (CA) and Dual Connectivity (DC). However, in case the timing intervals for the DCP occasion coincide with timing intervals defined for MUSIM operations, the convention techniques fail to handle the DRX adaptation.

Furthermore, an NR UE also performs various operations like Uplink (UL) data transmission from both the control plane and the user plane on Uplink Shared Channel (UL-SCH). The NR UE also perform transmission of various physical layer and layer 2 control information including transmission of Buffer Status Report (BSR), transmission of Scheduling Request (SR), transmission of Sounding Reference Signals (SRS) and Demodulation Reference Signal (DMRS), transmission of Hybrid Automatic Repeat Request (HARQ) feedback, transmission of Channel State Information (CSI), and the Random Access (RA) operation. The UE transmits uplink data on UL-SCH based on the resource allocation from the network. Such resources may be allocated dynamically through Downlink Control Information (DCI) or semi-statically. If no resources are available, a Scheduling Request (SR) may be transmitted by the UE. The BSR is transmitted to inform the network about the uplink buffer. The HARQ feedback in the UL transmission informs the network whether the downlink data is received successfully by the UE. The SRS and DMRS are reference signals transmitted by the UE to inform the network about the uplink conditions. The CSI is transmitted by the UE to inform the network about the channel conditions faced by the UE. However, if the UL transmission or transmission of any of the above-mentioned information coincides with the timing intervals for MUSIM operations, the conventional techniques fail to handle such transmissions.

Also, the UE may use the RA to achieve UL time synchronization. The RA is used during initial access, handover, Radio Resource Control (RRC) connection re-establishment procedure, scheduling request transmission, Secondary Cell Group (SCG) addition/modification, beam failure recovery, and data or control information transmission in UL by non-synchronized UE in RRC CONNECTED state. The RA may be performed either in 4 steps or 2 steps. Further, the RA may either be contention-based or contention-free. In 4-step contention-based RA, the UE first transmits the RA preamble (also referred to as Msg1) and then waits for Random Access Response (RAR) in the RAR window. RAR may also be referred to as Msg2. If the RAR corresponding to its RA preamble transmission is received, the UE transmits message 3 (Msg3) in a UL grant received in RAR. After transmitting the Msg3, the UE starts a contention resolution timer. While the contention resolution timer is running, if the UE receives a Physical Downlink Control Channel (PDCCH) addressed to Cell Radio Network Temporary Identifier (C-RNTI) included in Msg3, the contention resolution is considered successful, the contention resolution timer is stopped, and RA procedure is completed. In 2 step contention-based RA, in the first step, the UE transmits the RA preamble on Physical Random Access Channel (PRACH) and a payload (i.e., Medium Access Control Protocol Data Unit (MAC-PDU)) on Physical Uplink Shared Channel (PUSCH). The RA preamble and payload transmission are also referred to as MsgA. In the second step, after MsgA transmission, the UE monitors for a RAR from the network within a configured window. The contention-free RA is successful after receiving RAR. However, if the RAR timing interval coincides with the timing interval for MUSIM operations, the conventional techniques fail to provide any solution to handle such a situation.

Thus, there is a need to provide a solution to overcome the above challenges during MUSIM operations.

### Disclosure of Invention

### Technical Problem

This summary is provided to introduce a selection of concepts in a simplified format that is further described in the detailed description of the inventive concepts. This summary is not intended to identify key or essential inventive concepts, nor is it intended for determining the scope of the inventive concepts.

The present disclosure provides a method and device for handling discontinuous reception (DRX) adaptation, uplink (UL) operations, and/or random access (RA) adaptation in a wireless communication system supporting multiple subscriber identity module (MUSIM) operations.

### Solution to Problem

According to embodiments of the present disclosure, a method performed by a user equipment (UE) in a wireless communication system supporting multiple subscriber identity module (MUSIM) operations is disclosed. The method includes receiving, from a base station, discontinuous reception (DRX) configuration information, configuration information on downlink control information (DCI) with a cyclic redundancy check (CRC) scrambled by power saving-radio network temporary identifier (PS-RNTI) (DCP) occasion, and MUSIM gap configuration information. The DRX configuration information includes the DRX cycle information. The configuration information on the DCP occasion includes one or more timing intervals for wakeup indication. The MUSIM gap configuration information includes one or more timing intervals for the MUSIM operations. The method also includes determining whether the one or more timing intervals for wakeup indication associated with a current DRX cycle overlaps with at least one of the one or more timing intervals for the MUSIM operations based on the DRX configuration information, the configuration information on the DCP occasion, and the MUSIM gap configuration information. Further, the method includes starting a DRX-ON duration timer after the at least one of the one or more timing intervals for the MUSIM operations has lapsed in case that the one or more timing intervals for wakeup indication associated with the current DRX cycle overlap with at least one of the one or more timing intervals for the MUSIM operations.

According to embodiments of the present disclosure, a method performed by a user equipment (UE) in a wireless communication system supporting multiple subscriber identity module (MUSIM) operations is disclosed. The method includes receiving, from a base station, MUSIM gap configuration information including at least one or more timing intervals for the MUSIM operations. The method also includes generating a trigger message for performing uplink (UL) transmission. The trigger message includes information indicating at least timing for the UL transmission. The method further includes determining whether the timing for the UL transmission overlaps with at least one of the one or more timing intervals for the MUSIM operations based on the MUSIM gap configuration information and the information included in the trigger message. Furthermore, the method includes skipping the UL transmission for at least the one or more timing intervals for the MUSIM operations in case the timing for the UL transmission overlaps with at least one of the one or more timing intervals for the MUSIM operations.

According to embodiments of the present disclosure, A method performed by a user equipment (UE) in a wireless communication system supporting multiple subscriber identity module (MUSIM) operations is disclosed. The method includes receiving, from a base station, MUSIM gap configuration information including at least one or more timing intervals for the MUSIM operations. The method also includes transmitting, to the base station, a message for performing random access (RA) operation. The method further includes identifying a timing interval for Random Access Response (RAR) based on the transmitted message for performing the RA operation. Moreover, the method includes determining whether the identified timing interval for the RAR overlaps with at least one of the one or more timing intervals for the MUSIM operations based on a comparison of the MUSIM gap configuration information with the identified timing interval for the RAR. Further, the method includes skipping the MUSIM operations to wait for the RAR from the base station in case that the timing interval for the RAR overlaps with at least one of the one or more timing intervals for the MUSIM operations.

According to embodiments of the present disclosure, a user equipment (UE) in a wireless communication system supporting multiple subscriber identity module (MUSIM) operations is disclosed. The UE includes a transceiver and at least one processor communicably coupled to the memory. The at least one processor is configured to receive, from a base station, discontinuous reception (DRX) configuration information, configuration information on downlink control information (DCI) with a cyclic redundancy check (CRC) scrambled by power saving-radio network temporary identifier (PS-RNTI) (DCP) occasion, and MUSIM gap configuration information. The DRX configuration information includes the DRX cycle information, the configuration information on the DCP occasion includes one or more timing intervals for wakeup indication, and the MUSIM gap configuration information includes one or more timing intervals for the MUSIM operations. The at least one processor is configured to determine whether the one or more timing intervals for wakeup indication associated with a current DRX cycle overlaps with at least one of the one or more timing intervals for the MUSIM operations based on the DRX configuration information, the configuration information on the DCP occasion, and the MUSIM gap configuration information. The at least one processor is further configured to start a DRX-ON duration timer after the at least one of the one or more timing intervals for the MUSIM operations has lapsed in case that the one or more timing intervals for wakeup indication associated with the current DRX cycle overlap with at least one of the one or more timing intervals for the MUSIM operations.

According to embodiments of the present disclosure, a user equipment (UE) in a wireless communication system supporting multiple subscriber identity module (MUSIM) operations is disclosed. The system includes a transceiver and at least one processor communicably coupled to the memory. The at least one processor is configured to receive, from a base station, MUSIM gap configuration information including at least one or more timing intervals for the MUSIM operations. The at least one processor is configured to generate a trigger message for performing uplink (UL) transmission. The trigger message includes information indicating at least timing for the UL transmission. The at least one processor is further configured to determine whether the timing for the UL transmission overlaps with at least one of the one or more timing intervals for the MUSIM operations based on the MUSIM gap configuration information and the information included in the trigger message. The at least one processor is also configured to skip the UL transmission for at least the one or more timing intervals for the MUSIM operations in case that the timing for the UL transmission overlaps with at least one of the one or more timing intervals for the MUSIM operations.

According to embodiments of the present disclosure, a user equipment (UE) in a wireless communication system supporting multiple subscriber identity module (MUSIM) operations is disclosed. The system includes a transceiver and at least one processor communicably coupled to the memory. The at least one processor is configured to receive, from a base station, MUSIM gap configuration information including at least one or more timing intervals for the MUSIM operations. The at least one processor is also configured to transmit a message for performing random access (RA) operation to the base station. The at least one processor is further configured to identify a timing interval for random access response (RAR) based on the transmitted message for performing the RA operation. Furthermore, the at least one processor is configured to determine whether the identified timing interval for the RAR overlaps with at least one of the one or more timing intervals for the MUSIM operations based on a comparison of the MUSIM gap configuration information with the identified timing interval for the RAR. Moreover, the at least one processor is configured to skip the MUSIM operations to wait for the RAR from the base station in case that the timing interval for the RAR overlaps with at least one of the one or more timing intervals for the MUSIM operations.

To further clarify the advantages and features of the inventive concepts, a more particular description of the inventive concepts will be rendered by reference to specific examples thereof, which are illustrated in the appended drawings. It is appreciated that these drawings depict only embodiments of the inventive concepts and are therefore not to be considered limiting its scope. The inventive concepts will be described and explained with additional specificity and detail with the accompanying drawings.

### BRIEF DESCRIPTION OF DRAWINGS

These and other features, aspects, and advantages of the inventive concepts will become better understood when the following detailed description is read with reference to the accompanying drawings in which like characters represent like parts throughout the drawings, wherein:

FIG. 1 illustrates a sequence of operations depicting communication between a Multi-Subscriber Identity Module (MUSIM UE) and a network, according to state of the art;

FIG. 2 illustrates a timing diagram depicting a challenge associated with handling Discontinuous Reception (DRX) adaptation during MUSIM operation, according to state of the art;

FIG. 3 illustrates a timing diagram depicting a challenge associated with handling Uplink (UL) transmission during MUSIM operation, according to state of the art;

FIG. 4 illustrates a timing diagram depicting a challenge associated with handling Random Access (RA) adaptation during MUSIM operation, according to state of the art;

FIG. 5 illustrates a process flow depicting a method for performing DRX adaptation during MUSIM operations, according to embodiments of the present disclosure;

FIG. 6 illustrates a process flow depicting a method for performing UL transmission adaptation during MUSIM operations, according to embodiments of the present disclosure;

FIG. 7 illustrates a process flow depicting a method for performing RA transmission adaptation during MUSIM operations, according to embodiments of the present disclosure;

FIG. 8 is a diagram illustrating the configuration of a device for the UE in a wireless communication system, according to embodiments of the present disclosure; and

FIG. 9 is a diagram illustrating the configuration of a device for the network in a wireless communication system, according to embodiments of the present disclosure.

Further, skilled artisans will appreciate that elements in the drawings are illustrated for simplicity and may not have been necessarily drawn to scale. For example, the flow charts illustrate the method in terms of prominent operations involved to help to improve understanding of aspects of the inventive concepts. Furthermore, in terms of the construction of the device, one or more components of the device may have been represented in the drawings by conventional symbols, and the drawings may show only those specific details that are pertinent to understanding embodiments of the inventive concepts so as not to obscure the drawings with details that will be readily apparent to those of ordinary skill in the art having the benefit of the description herein.

### Mode for the Invention

It should be understood at the outset that although illustrative implementations of embodiments of the present disclosure are illustrated below, the inventive concepts may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “embodiments” may refer to no embodiments, to one embodiment, to several embodiments, or to all embodiments. Accordingly, the term “embodiments” is defined as meaning “no embodiment, or one embodiment, or more than one embodiment, or all embodiments.”

The terminology and structure employed herein are for describing, teaching, and illuminating embodiments and their specific features and elements and do not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more.” or “one or more element is REQUIRED.”

Unless otherwise defined, all terms, and especially any technical and/or scientific terms, used herein may be taken to have the same meaning as, or a similar meaning to, that commonly understood by one having ordinary skill in the art.

The terms “user”, “user device”, “user equipment”, or “UE” may be used interchangeably throughout the description.

The term “DCP” may stand for Downlink control information with Cyclic redundancy check scrambled by Power saving-radio network temporary identifier. Further, the terms “DCP occasion” and “timing intervals for wake indication” have been used interchangeably throughout the specification.

Also, the phrases “timing intervals for MUSIM operations” and “MUSIM gaps” have been used interchangeably throughout the description.

Embodiments of the inventive concepts will be described below in detail with reference to the accompanying drawings.

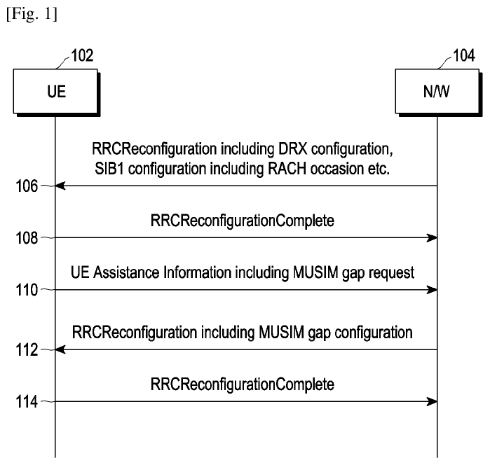

FIG. 1 illustrates a sequence of operations depicting communication between a Multi-Subscriber Identity Module (MUSIM UE) 102 (interchangeably referred as “the UE 102”) and a network 104, according to state of the art. Examples of the UE 102 may include, a smartphone, a tablet, a laptop, a personal computing device, and so forth. The UE 102 may be configured to support multiple Universal SIMs (USIMs), and thereby referred to as the MUSIM UE 102. Particularly, the MUSIM UE 102 is capable of hosting more than one USIM to establish a connection with two or more different networks and thereby allows a user to have different connection plans, different profiles, and increased connectivity/reliability with the support of multiple network connections.

Further, the network 104 may correspond to 5th Generation (5G) network. The network 104 may correspond to network components such as a base station. The term base station may generally refer to a fixed station that communicates with the UE 102 and/or other base stations. Specifically, the base station may exchange data and control information by communicating with the UE 102 and/or other base stations. For example, the base station may also be referred to as a Node B, an evolved-Node B (eNB), a next generation Node B (gNB), a sector, a site, a base transceiver system (BTS), an access point (AP), a relay node, a remote radio head (RRH), a radio unit (RU), a small cell, or the like. In the present specification, a base station or a cell may be interpreted in a comprehensive sense to indicate some area or function covered by a base station controller (BSC) in CDMA, a Node-B in WCDMA, an eNB in LTE, a gNB or sector (site) in 5G, and the like, and may cover all the various coverage areas such as megacell, macrocell, microcell, picocell, femtocell, and relay node, and so forth.

At operation step 106, the network 104 may transmit Radio Resource Control (RRC) reconfiguration information to the UE 102. The RRC reconfiguration information may include Discontinuous Reception (DRX) configuration information, System Information Block 1 (SIB1) configuration information, and so forth. In an embodiment, the SIB1 configuration information may include Random Access Channel occasion information. The network 104 may transmit the RRC configuration information in response to the establishment of a connection with the UE 102 or the detection of a change in the operational condition of the UE 102 and/or the network 104. Specifically, the RRC configuration information may be required to establish and/or maintain a radio link between the UE 102 and the network 104. The RRC reconfiguration information may also include, but is not limited to, system information, security configuration, radio bearer configuration, measurement configuration, and mobility configuration and other configuration. The system information may correspond to essential network information such as, but not limited to, cell identity, cell reselection criteria, neighbor cell information, broadcast system parameters, and so forth, and may be included in RRC Reconfiguration during handover. The system information may enable the UE 102 to synchronize with the network 104. The security configuration may correspond to security-related information such as, but not limited to, cryptographic keys, security related parameters, integrity protection techniques, and so forth. The security configuration enables secure communication between the UE 102 and the network 104. The radio bearer configuration may define parameters related to the establishment and maintenance of radio bearers, which may be defined as logical channels used for transmitting data between the UE 102 and the network 104. Further, the measurement configuration may include parameters, but not limited to, signal strength, signal quality, neighboring cell measurements, and so forth. Specifically, the measurement configuration may assist the UE 102 to perform cell selection, handover decisions, and radio resource management. The mobility configuration may include parameters such as, but not limited to, handover control, cell reselection, access control, and so forth. The network 104 may be configured to directly transmit the RRC information to the connected UE 102 or based on a request received from the UE 102. The other configuration may inform the UE whether it can request for specific configurations such as MUSIM gaps. Moreover, the information included in the RRC reconfiguration information may vary based on the type of the network 104.

At operation step 108, the UE 102 may acknowledge the reception of the transmitted RRC configuration information by transmitting a “RRCReconfigurationComplete” message to the network 104. Specifically, the “RRCReconfigurationComplete” message may indicate a successful completion of the RRC reconfiguration procedure. For instance, when the network 104 identifies a change in configuration of the radio resources allocated to the UE 102, the network 104 transmits the RRCreconfigurtaion information. The UE 102 processes the received RRCreconfiguration information and makes the required changes to at least one of radio resource allocation, radio bearer configuration, mobility management, and/or other relevant parameters. Once the required modifications are made, the UE 102 transmits the RRCReconfigurationComplete” message to the network 104. In some embodiments, the RRCReconfigurationComplete message may include information such as, but not limited to, status indicators, confirmation flags, or any additional parameters required by the network 104 to validate the completion of the reconfiguration.

At operation step 110, the UE 102 may transmit a UE assistance information which may also include MUSIM gap request. Specifically, the MUSIM gap request may indicate timing intervals that may be required by the UE 102 to perform MUSIM operations. Specifically, the UE 102 may indicate to the network 104 that the UE 102 needs to perform MUSIM operations and accordingly the UE 102 requires some resources for specific durations of time. In some embodiments, the UE 102 may use the UE assistance information to notify the network 104 node about network switching and/or required gaps for MUSIM operations.

At operation step 112, the network 104 may transmit the RRCreconfiguration information including MUSIM gap configuration in response to the UE assistance information including the MUSIM gap request. The MUSIM gap configuration may define the timing intervals allowed by the network 104 for the MUSIM operations. Specifically, the network 104 may configure the UE 102 to support the MUSIM operations. The RRCreconfiguration information may include assistance information of the MUSIM gap or MUSIM leave. In some embodiments, using the RRCreconfiguration information, the network 104 may indicate whether the UE 102 need to leave the RRC-connected state or remain in a connected state to perform the MUSIM operations.

At operation step 114, the UE 102 may transmit the RRCreconfigurationcomplete message on successful configuration of the network resources based on the RRCreconfiguration information including MUSIM gap configuration.

The operation steps explained above correspond to various steps of communication that may occur between the UE 102 and the network 104 during the establishment and maintenance of the radio connection and performing the MUSIM operations. Embodiments discussed above are exemplary in nature and the UE 102 and the network 106 may communicate with each other in any suitable manner to maintain the RRC connected state and perform MUSIM operation.

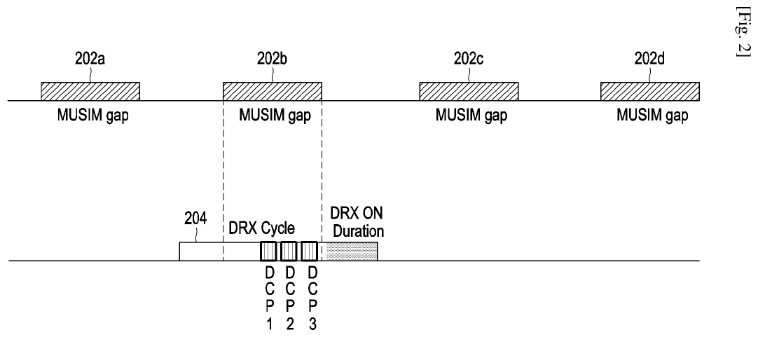

FIG. 2 illustrates a timing diagram depicting a challenge associated with handling Discontinuous Reception (DRX) adaptation during MUSIM operation, according to state of the art. FIG. 2 illustrates a plurality of MUSIM gaps 202a-202d which may be configured by the network 104 to perform the MUSIM operations. The MUSIM gaps 202a-202d may be configured by the network 104 for the UE 102 using the MUSIM gap configuration. The MUSIM gap configuration may be determined based on a preference of the UE 102, as indicated in the UE assistance information transmitted at the operation step 110, shown in FIG. 1. The MUSIM gaps 202a-202d may be either periodic or aperiodic in nature. The network 104 may define the length of the MUSIM gaps, repetition of the MUSIM gaps, an offset of the MUSIM gaps, and other MUSIM-related information in the MUSIM gap configuration. The timing intervals for the MUSIM gaps may be defined in System Frame Numbers (SFN) and/or a number of subframes. Therefore, the MUSIM gap configuration information as defined by the network 104 may include an indication of a starting SFN and/or the number of subframes for the MUSIM gaps.

FIG. 2 also depicts the DRX configuration of the UE 102. The DRX configuration may be defined by the network 104 in an initial RRC configuration and/or RRC reconfiguration information. The network 104 configures DRX configuration to save resources and/or power at the UE 102. Specifically, the DRX configuration specifies a sleep duration of the UE 102 when the UE 102 is not required to transmit and/or receive data to and from the network 104. The DRX configuration may include parameters such as, DRX cycle length, ON-duration timer, DRX inactivity timer, and paging configuration. For example, the DRX configuration may define a DRX cycle 204 with the DRX ON-duration as highlighted in FIG. 2. Further, the DRX cycle length may define a duration of DRX cycle i.e., timing interval between consecutive wake-up periods. The DRX cycle may be defined in milliseconds. The ON-duration timer may specify a duration for which the UE 102 remains awake after waking up from the sleep state. The ON-duration timer may also refer to as a timing interval between two consecutive DRX cycles. The DRX inactivity timer may be defined as a maximum duration of inactivity during the active period of the UE 102, before the UE 102 may return to the sleep state. The paging configuration may define timing intervals for paging occasions and paging cycles. For the sake of brevity, FIG. 2 only depicts DRX cycle 204 and the DRX ON-timer duration.

Further, the network 104 may also configure DCP occasions and/or events which may allow the UE 102 to wake up for a short period of time to receive an indication and/or flag indicating whether to wake up in an upcoming DRX-ON timer. The network 104 may configure DCP occasions via the DCP configuration information which may be transmitted to the UE 102 along with the RRC configuration and/or reconfiguration information or transmitted separately.

However, as illustrated, when all the DCP occasions coincide with the timing interval for MUSIM operations, the UE 102 may fail to receive wake up indication from the network 104. In such a case, the UE 102 may inadvertently remain in either a sleep state or an ON state, which may not be desirable. For instance, if the wake up indication during a DCP occasion corresponds to an indication that the UE 102 may remain in the sleep state during the next ON-timer duration, and the UE 102 does not receive said indication, the UE 102 may wake up which results in loss of resource and power. Accordingly, FIG. 2 depicts the challenge associated with the DRX adaptation during the MUSIM operations.

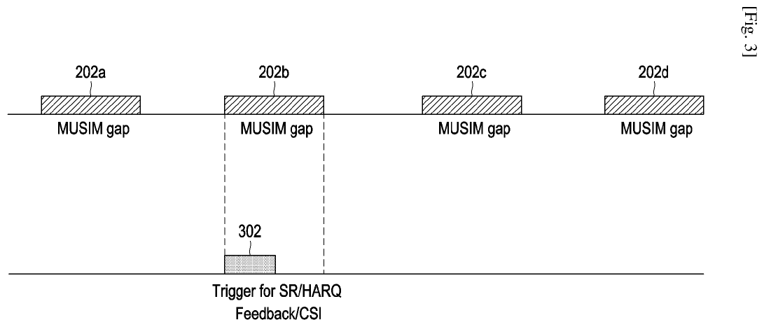

FIG. 3 illustrates a timing diagram depicting a challenge associated with handling Uplink (UL) transmission during MUSIM operation, according to state of the art. The UL transmission may refer to the transmission of information from the UE 102 to the network 104. Examples of some general UL transmission may include, but are not limited to, Scheduling Request (SR) transmission, Hybrid Automatic Repeat Request (HARQ) feedback transmission, Channel State Information (CSI) transmission, UL grant transmission, UL power control transmission, UL synchronization transmission, and so forth. The SR may correspond to a control signal which may be sent by the UE 102 to request the network 104 to allocate resources for the UL transmission. The HARQ may correspond to a technique that may be used by the UE 102 to control errors in both UL and Downlink (DL) transmissions. The CSI may correspond to information about the quality and conditions of the wireless channel between the UE 102 and the network 104.

However, when the UE 102 trigger such UL transmission during the MUSIM gap, as indicated by trigger 302, the UE 102 and the network 104 fails to handle the scenario. Specifically, the resources corresponding to the UE 102 and/or the network 104 fail to identify which request to accommodate and/or perform and which request to skip. Accordingly, FIG. 3 depicts the challenge associated with the UL transmission adaptation during the MUSIM operations.

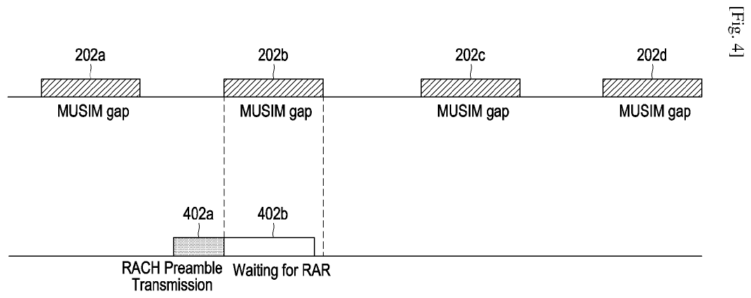

FIG. 4 illustrates a timing diagram depicting a challenge associated with handling Random Access (RA) adaptation during MUSIM operation, according to state of the art.

The UE 102 may perform RA to establish a connection with a network or transmit data to the network 104. The UE 102 may perform RA by transmitting a short access request message (for example, RACH preamble transmission 402a) to the network. In an embodiment, the RACH preamble may include information such as, an identification of the UE 102, a reason for request such as, for the establishment of the connection or the transmission of the data.

Once the RA is performed, the UE 102 waits for Random Access Response (RAR) message 402b from the network 104. The RAR message may include information necessary for the UE 102 to complete the RA procedure. In some embodiments, the RAR message may include information such as, but not limited to, timing advance, resource assignments, and temporary identifiers. In an embodiment, the network 104 may use the RAR message to instruct the UE 102 on how to complete the RA procedure and inform the UE 102 about the allocated resources, such as uplink and downlink channels or transmission time intervals, and any other relevant information required for complete of the RA procedure.

However, when the timing interval for RAR message 402b coincides with the timing interval for the MUSIM operations, the UE 102 and/or the network 104 fails to handle the scenario. Specifically, the UE 102 may not receive the transmitted RAR message and accordingly fails to complete the RA procedure. Accordingly, FIG. 4 depicts the challenge associated with the RA transmission adaptation during the MUSIM operations.

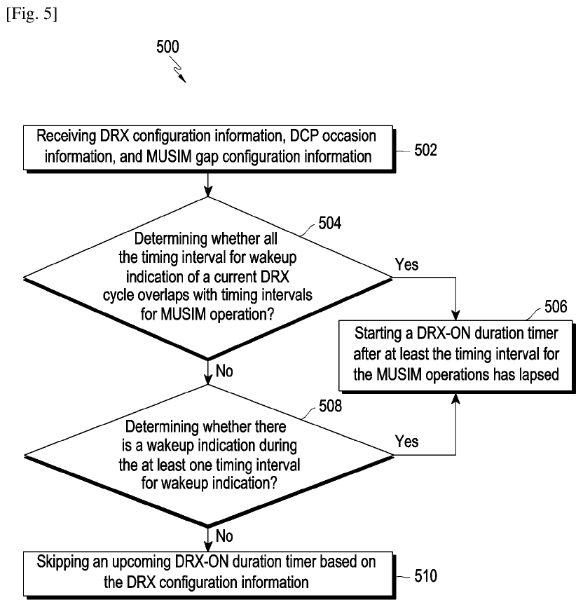

FIG. 5 illustrates a process flow depicting a method 500 for performing DRX adaptation during MUSIM operations, according to embodiments of the present disclosure. The method 500 may be performed by the UE 102 in communication with the network 104.

At step 502, the method 500 may include receiving the DRX configuration information, the DCP occasion information, and the MUSIM gap configuration information from the network 104. In an embodiment, the DRX configuration information includes the DRX cycle information (for example, the DCP cycle 202, as shown in FIG. 2). The DCP occasion information includes one or more timing intervals (for example, DCP1, DCP2, DPC3, as shown in FIG. 2) for wakeup indication, and the MUSIM gap configuration information includes one or more timing intervals (for example, 202a-202d) for the MUSIM operations. In some embodiments, the DRX configuration information may also include information such as, but not limited to, the DRX-slot offset timing interval, the DRX-on duration timer, the DRX-inactivity timer, and the DRX-cycle interval, as explained above in reference to FIG. 2.

At step 504, the method 500 may include determining whether the timing intervals for wakeup indication associated with a current DRX cycle overlaps with at least one of the one or more timing intervals for the MUSIM operations based on the DRX configuration information, the DCP occasion information, and the MUSIM gap configuration information. Specifically, the UE 102 may compare the SFN and/or subframes timing for the MUSIM operations and the DPC occasions to determine whether the timing intervals for wake indication overlaps with the timing interval for MUSIM operations. Moreover, the timing interval for wake up indication may also be referred to as the DCP occasions and/or events and such terms/phrase may be used interchangeably throughout the description.

Further, upon determining that the one or more timing intervals for wakeup indication associated with the current DRX cycle overlap with at least one of the one or more timing intervals for the MUSIM operations, the method 500 may perform step 506 indicating starting of the DRX-ON duration timer after the at least one of the one or more timing intervals for the MUSIM operations has lapsed. In some embodiments, the UE 102 may start the DRX ON-duration timer after the drx-SlotOffset from the beginning of the subframe. The UE 102 may identify this subframe where active time starts based on the received DRX configuration. Specifically, the method 500 may include identifying DRX-slot offset timing interval and a subframe where DRX ON period starts from the DRX configuration information and starting the DRX-ON duration timer after a lapse of the DRX-slot offset timing interval in the subframe.

However, upon determining that at least one timing interval from the one or more time intervals for wakeup indication does not overlap with at least one of the one or more timing intervals for the MUSIM operations, the method 500 may perform step 508 indicating determining whether there is a wakeup indication during the at least one timing interval for wakeup indication. Specifically, even if there is a single DCP occasion that does not overlap with the timing interval for MUSIM gap i.e., the UE 102 may be able to receive the wake indication during said DCP occasion, the UE 102 may operation based on the wake indication received during said DCP occasion. For instance, at step 510, upon determining that there is no wakeup indication during the at least one timing interval for wakeup indication, the method 500 may include skipping an upcoming DRX-ON duration timer based on the DRX configuration information i.e., the UE 102 may skip the upcoming DRX-ON duration upon determining that there is no wakeup flag and/or indication.

Further, upon determining that there is a wakeup indication during the at least one timing interval for wakeup indication, the method 500 may include performing step 506 i.e., starting the DRX-ON duration timer after the at least one of the one or more timing intervals for the MUSIM operations has lapsed.

In an embodiment, a sample set of changes in New Radio Medium Access Control (NR MAC) specification in view of discussed embodiment is given below:
2>if DCP monitoring is configured for the active DL BWP as specified in TS 38.213 [6], clause 10.3:
3>if DCP indication associated with the current DRX cycle received from lower layer indicated to start drx-onDurationTimer, as specified in TS 38.213 [6]; or
3>if all DCP occasion(s) in time domain, as specified in TS 38.213 [6], associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap or MUSIM gap, or when the MAC entity monitors for a PDCCH transmission on the search space indicated by recovery SearchSpaceId of the SpCell identified by the C-RNTI while the ra-Response Window is running (as specified in clause 5.1.4); or
3>if ps-Wakeup is configured with value true and DCP indication associated with the current DRX cycle has not been received from lower layers:
4>start drx-onDurationTimer after drx-SlotOffset from the beginning of the subframe.

In an alternative embodiment, in case all the DCP occasions associated with the current DRX cycle overlap with the timing intervals (MUSIMN gaps) for the MUSIM operations, the UE 102 may skip to wake up during the active time of the next DRX cycle, unless DCP indicator is to start ON Duration timer or PS-wake up is true.

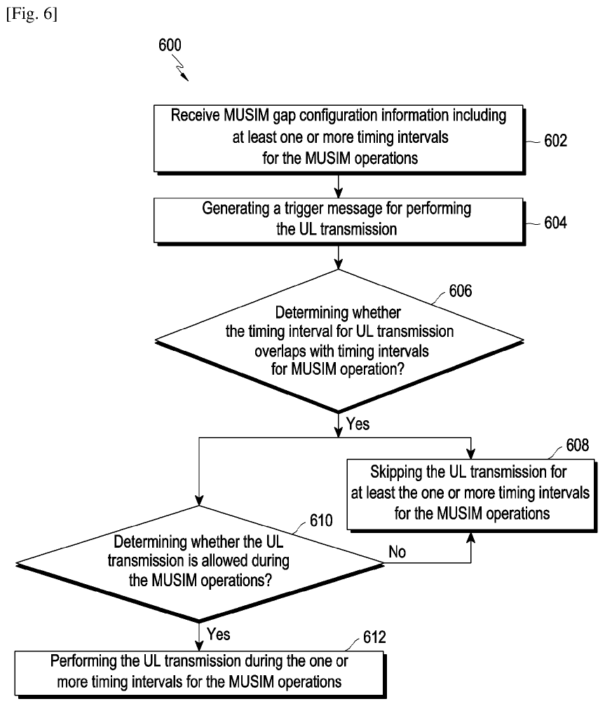

FIG. 6 illustrates a process flow depicting a method 600 for performing UL transmission adaptation during MUSIM operations, according to embodiments of the present disclosure. The method 600 may be performed by the UE 102 in communication with the network 104.

At step 602, the method 600 may include receiving the MUSIM gap configuration information including at least one or more timing intervals (202a-202d) for the MUSIM operations from the network 104. At step 604, the method 600 may include generating a trigger message for performing the UL transmission. The trigger message includes information indicating at least the timing for the UL transmission.

At step 606, the method 600 may include determining whether the timing for the UL transmission overlaps with at least one of the one or more timing intervals for the MUSIM operations based on the MUSIM gap configuration information and the information included in the trigger message. Further, in one embodiment, upon determining that the timing for the UL transmission overlaps with at least one of the one or more timing intervals for the MUSIM operations, the method 600 may include performing step 608 corresponding to skipping the UL transmission for at least the one or more timing intervals for the MUSIM operations.

In another embodiment, upon determining that the timing for the UL transmission overlaps with at least one of the one or more timing intervals for the MUSIM operations, the method 600 may include performing step 610 corresponding to determining whether the UL transmission is allowed during the one or more timing intervals for the MUSIM operations. In an embodiment, the UE 102 may determine whether the UL transmission is allowed during the timing intervals for the MUSIM operation based on the MUSIM gap configuration received from the network. Further, upon determining that the UL transmission is allowed during the timing intervals for the MUSIM operations, the method 600 may include performing step 612 corresponding to performing the UL transmission during the one or more timing intervals for the MUSIM operations. However, in case the UE 102 determines that the UL transmission is not allowed during the MUSIM operation, the method 600 may perform the step 608, i.e., skip the UL transmission for the timing intervals for the MUSIM operations.

In some embodiments, the UE 102 may receive a one bit indication from the network 104, which may define whether the UL transmission is allowed during the timing interval for MUSIM operations. The one bit indication may be referred as “ulAllowedDuringGap”, which may be defined as “ulAllowedDuringGap ENUMERATED {true} OPTIONAL” i.e., if the indication is received, the indication is always “True” and otherwise specified as “False”. Based on said indication, the UE 102 may decide whether the UE 102 is allowed to perform UL transmissions if a MUSIM gap overlaps with UL transmission. In some other embodiments, the UE 102 may inform the network 104 about its capabilities to transmit the UL transmission during the timing interval for the MUSIM operations.

Further, the disclosed embodiment may be reflected in the NR MAC specification TS 38.321, as below:
5.X Handling of MUSIM gaps

During a MUSIM gap, the MAC entity shall, on the Serving Cell(s) in the MUSIM gap configured by musim-GapConfig as specified in TS 38.331 [5]:
1>If the ulAllowedDuringGap is true for the MUSIM gap
1>may transmit on UL except for Msg3 or the MSGA payload as specified in clause 5.4.2.2;
Else
2>not transmit on UL except for Msg3 or the MSGA payload as specified in clause 5.4.2.2;

In yet another embodiment, the UE 102 may receive an indication ‘ulProhibitedDuringGap”, which may be defined as “ulProhibitedDuringGap ENUMERATED {true} OPTIONAL” i.e., if the indication “ulProhibitedDuringGap” is received, the indication is always “True” and otherwise the indication is specified as “False” from the network 104. Thus, if the UE 102 receives said indication, the UE 102 may not perform UL transmission, and if the UE 102 doesn't receive said indication, the UE 102 may perform UL transmission during the timing intervals for MUSIM operations.

In yet another embodiment, the UE 102 may receive whether it is allowed to perform UL transmission during the MUSIM gap explicitly as an enumerated {allowed/prohibited} using an indication “ulDuringGap ENUMERATED {allowed, prohibited} OPTIONAL”. The UE 102 may act as per the received indication i.e., if the indication is “allowed”, the UE 102 may perform UL transmission during the overlapping timing intervals for MUSIM operations and if the indication is prohibited, the UE 102 may not perform the UL transmission during the said overlapping timing intervals.

In yet another embodiment, the UE 102 may decide whether to perform MUSIM operations during the overlapping timing intervals or perform the UL transmissions based on the condition of a radio link in connected USIM and/or a condition of a radio link in idle/INACTIVE USIM. The UE 102 may perform the operations required for the USIM which has a weaker radio link.

In alternative embodiments, if the MUSIM gap type is a periodic gap, the UE 102 may perform UL transmissions and may not perform MUSIM operations during the overlapping timing interval. Further, if the gap is an aperiodic gap, the UE 102 may perform MUSIM operations during the overlapping time intervals and may not perform the UL transmissions. In an alternate embodiment, if the gap type is an aperiodic gap, the UE 102 may perform UL transmissions and may not perform the MUSIM operations during the overlapping time intervals, while if the gap is a periodic gap, the UE 102 may perform the MUSIM operations during the overlapping timing intervals and may not perform the UL transmissions.

In another embodiment, upon determining that the UL transmission is allowed during the timing intervals for the MUSIM operations, the method 600 may include identifying a priority of the MUSIM operations based on the MUSIM gap configuration information. The method 600 may also include identifying a priority of the UL transmission based on the information included in the trigger message. Thereafter, the method 600 may include comparing the priority of the MUSIM operations with the priority of the UL transmission and determining whether to perform the MUSIM operations or the UL transmission based on said comparison. For instance, if the priority of MUSIM operations is high, the method 600 may skip the UL transmission in case of overlap with the MUSIM operations, as discussed above. However, in case, the UL transmission has higher priority, the method 600 may include either performing the UL transmission during the MUSIM operations or skipping the MUSIM operations to perform UL transmission.

For example, in a case of paging monitoring, the MUSIM operations may have high priority as compared to UL transmission or a threshold, and the UE 102 may prioritize the MUSIM operations during overlapping timing duration. On the other hand, in a case of idle mode measurement, the MUSIM operations may have a lower priority as compared to the UL transmission or the threshold, and the UE 102 may prioritize the UL transmission during the overlapping timing duration.

In an embodiment, the solution proposed above may be defined in NR MAC specification TS 38.321, as follow:
5.X Handling of MUSIM gaps

During a MUSIM gap, the MAC entity shall, on the Serving Cell(s) in the MUSIM gap configured by musim-GapConfig as specified in TS 38.331 [5]:
1>If the MUSIM gap is a low priority gap
1>may transmit on UL-SCH except for Msg3 or the MSGA payload as specified in clause 5.4.2.2;
Else
2>not transmit on UL-SCH except for Msg3 or the MSGA payload as specified in clause 5.4.2.2;

An example of handling Sounding Reference Signals (SRS) during overlapping timing intervals for MUSIM operations may be explained as follow. In an embodiment, if a MUSIM gap overlaps with SRS reporting, the UE 102 may decide whether to perform the MUSIM operations or SRS reporting during the overlapping timing intervals based on the MUSIM operation to be performed. Specifically, the UE 102 may prioritize the MUSIM operations or the SRS reporting based on a comparison of the priority corresponding to the MUSIM operations and the SRS reporting, as discussed above.

As per the specification, the above-discussed embodiment may be explained as:
5.X Handling of MUSIM gaps

During a MUSIM gap, the MAC entity shall, on the Serving Cell(s) in the MUSIM gap configured by musim-GapConfig as specified in TS 38.331 [5]:
1>If the MUSIM gap is a low priority gap
1>may report SRS
Else
2>not report SRS;

In an embodiment, the UE 102 may receive an indication “ulsrsProhibitDuringGap” from the network 104, which may be defined as “ulsrsProhibitedDuringGap ENUMERATED {true} OPTIONAL” i.e., if the indication is received, the indication is always “True” and otherwise the indication is “False”. Specifically, if the UE 102 receives the indication, the UE 102 may not perform the UL SRS reporting during the overlapping timing intervals and if the UE 102 doesn't receive the indication, the UE 102 may perform the UL SRS reporting during overlapping timing intervals for the MUSIM operations. In yet another embodiment, the UE 102 may receive whether the UE 102 is allowed to perform the UL SRS reporting during the overlapping timing interval explicitly as an enumerated {allowed/prohibited}. The indication may further be defined as “ulsrsDuringGap ENUMERATED {allowed, prohibited} OPTIONAL” i.e. if the indication is “allowed”, the UE 102 may perform the UL-SRS reporting and if the indication is prohibited, the UE 102 may not perform the UL-SRS reporting during the overlapping timing intervals for the MUSIM operations.

In yet another embodiment, the UE 102 may decide whether to perform MUSIM operations during the overlapping timing intervals or perform the SRS transmissions based on the condition of a radio link in connected USIM and/or a condition of a radio link in idle/INACTIVE USIM. The UE 102 may perform the desired operations required for the USIM which has a weaker radio link.

In alternative embodiments, if the MUSIM gap type is a periodic gap, the UE 102 may perform the UL SRS reporting and may not perform MUSIM operations during the overlapping timing interval. Further, if the gap is an aperiodic gap, the UE 102 may perform MUSIM operations during the overlapping time intervals and may not perform the UL SRS reporting. In an alternate embodiment, if the gap type is an aperiodic gap, the UE 102 may perform UL SRS reporting and may not perform the MUSIM operations during the overlapping time intervals, while if the gap is a periodic gap, the UE 102 may perform the MUSIM operations during the overlapping timing intervals and may not perform the UL SRS reporting.

An example of handling SR, CSI, or HARQ feedback transmission during MUSIM operations may be explained as follow. In an embodiment, if a MUSIM gap overlaps with SR, CSI, or HARQ feedback transmission, the UE 102 may decide whether to perform the MUSIM operations, SR, CSI, or HARQ feedback transmission during the overlapping timing intervals based on the MUSIM operation to be performed. Specifically, the UE 102 may prioritize the MUSIM operations, SR, CSI, or HARQ feedback transmission based on a comparison of the priority corresponding to the MUSIM operations and the SR, CSI, HARQ feedback transmission.

As per the specification, the above-discussed embodiment may be explained as:
5.X Handling of MUSIM gaps

During a MUSIM gap, the MAC entity shall, on the Serving Cell(s) in the MUSIM gap configured by musim-GapConfig as specified in TS 38.331 [5]:
1>If the MUSIM gap is a low priority gap;
1>may perform the transmission of HARQ feedback, SR, and CSI;
Else
2>not perform the transmission of HARQ feedback, SR, and CSI;

In an alternate embodiment, the UE 102 may receive an indication “ulHarqSrCsiAllowedDuringGap”, which may be defined as “ulHarqSrCsiAllowedDuringGap ENUMERATED {true} OPTIONAL—i.e., if the indication is received, the indication is always “True” and otherwise the indication is “False”. The network 104 may use said indication to inform the UE 102 whether the UE 102 is allowed to transmit HARQ feedback, SR, and CSI during the overlap timing intervals with the MUSIM operations. Specifically, if the UE 102 receives said indication, the UE 102 may transmit HARQ feedback, SR, and CSI during an overlapping MUSIM gap, and if the UE 102 doesn't receive said indication, the UE 102 may not transmit HARQ feedback, SR, and CSI during an overlapping MUSIM gap. In an embodiment, the UE 102 may inform the network 104 about its capability to transmit HARQ feedback, SR, and CSI during overlapping timing intervals for the MUSIM operations.

Further, the disclosed embodiment may be reflected in the NR MAC specification TS 38.321, as below:
5.X Handling of MUSIM gaps

During a MUSIM gap, the MAC entity shall, on the Serving Cell(s) in the MUSIM gap configured by musim-GapConfig as specified in TS 38.331 [5]:
1>If the ulHarqSrCsiAllowedDuringGap is true for the MUSIM gap
1>may perform the transmission of HARQ feedback, SR, and CSI
Else
2>not perform the transmission of HARQ feedback, SR, and CSI

In yet another embodiment, the UE 102 may receive an indication ‘ulHarqSrCsiProhibitDuringGap”, which may be defined as “ulHarqSrCsiProhibitDuringGap ENUMERATED {true} OPTIONAL” i.e., if the indication “ulHarqSrCsiProhibitDuringGap” is received, the indication is always “True” and otherwise the indication is specified as “False” from the network 104. Thus, if the UE 102 receives said indication, the UE 102 may not transmit HARQ feedback, SR, and CSI, and if the UE 102 doesn't receive said indication, the UE 102 may transmit HARQ feedback, SR, and CSI during the timing intervals for MUSIM operations.

In yet another embodiment, the UE 102 may receive whether it is allowed to transmit HARQ feedback, SR, and CSI reporting during the MUSIM gap explicitly as an enumerated {allowed/prohibited} using an indication “ulHarqSrCsiDuringGap ENUMERATED {allowed, prohibited} OPTIONAL”. The UE 102 may act as per the received indication i.e., if the indication is “allowed”, the UE 102 may transmit HARQ feedback, SR, and CSI reporting during the overlapping timing intervals for MUSIM operations and if the indication is prohibited, the UE 102 may not transmit HARQ feedback, SR, and CSI reporting during the said overlapping timing intervals.

In yet another embodiment, the UE 102 may decide whether to perform MUSIM operations during the overlapping timing intervals or perform SR, CSI, HARQ feedback transmissions based on the condition of a radio link in connected USIM and/or a condition of a radio link in idle/INACTIVE USIM. The UE 102 may perform the operations required for the USIM which has a weaker radio link.

In alternative embodiments, if the MUSIM gap type is a periodic gap, the UE 102 may perform SR, CSI, HARQ feedback transmission and may not perform MUSIM operations during the overlapping timing interval. Further, if the gap is an aperiodic gap, the UE 102 may perform MUSIM operations during the overlapping time intervals and may not perform SR or CSI or HARQ feedback transmission. In an alternate embodiment, if the gap type is an aperiodic gap, the UE 102 may perform SR or CSI or HARQ feedback transmission and may not perform the MUSIM operations during the overlapping time intervals, while if the gap is a periodic gap, the UE 102 may perform the MUSIM operations during the overlapping timing intervals and may not perform SR or CSI or HARQ feedback transmission.

In an embodiment, the UE 102 may receive a single indication “ulAllowedDuringGap” which inform whether UL operations are allowed during MUSIM gap. If the UE 102 receives said indication, the UE 102 may perform UL operations (such as, UL-SCH transmission, SRS reporting, SR/CSI/HARQ feedback transmission) during the MUSIM gaps, else the UE 102 may not perform any of the said UE operations.

The above embodiments may be specified as:
5.X Handling of MUSIM gaps

During a MUSIM gap, the MAC entity shall, on the Serving Cell(s) in the MUSIM gap configured by musim-GapConfig as specified in TS 38.331 [5]:
1>If the ulAllowedDuringGap is true for the MUSIM gap
2>may transmit on UL-SCH except for Msg3 or the MSGA payload as specified in clause 5.4.2.2;
2>may report SRS;
2>may perform the transmission of HARQ feedback, SR, and CSI
Else
2>not transmit on UL-SCH except for Msg3 or the MSGA payload as specified in clause 5.4.2.2;
2>not report SRS;
2>not perform the transmission of HARQ feedback, SR, and CSI

Alternatively, the UE 102 may receive an indication which may instruct the UE 102 that above-mentioned UL operations are not allowed (i.e., prohibited), and the UE 102 may perform the UL operations only if said indication is not received. Alternatively, the indication may provide an enumeration {allowed, prohibited} to the UE 102 indicating whether the above-mentioned UL operations may be performed.

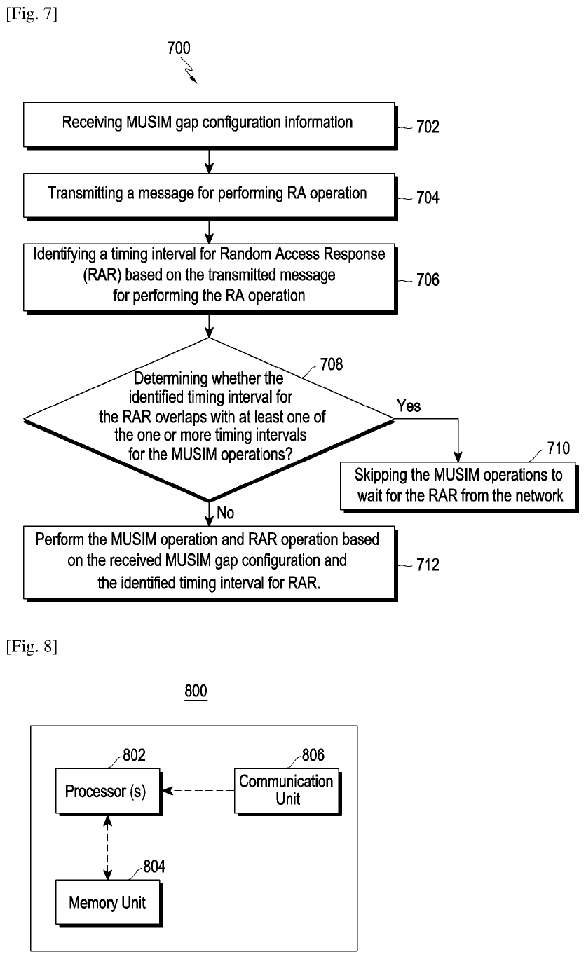

FIG. 7 illustrates a process flow depicting a method 700 for performing RA transmission adaptation during MUSIM operations, according to embodiments of the present disclosure. The method 700 may be performed by the UE 102 in communication with the network 104.

At step 702, the method 700 may include receiving MUSIM gap configuration information including at least one or more timing intervals for the MUSIM operations from the network 104. At step 704, the method 700 may include transmitting a message for performing RA operation to the network 104. Next at step 706, the method 700 may include identifying a timing interval for Random Access Response (RAR) based on the transmitted message for performing the RA operation. Further, at step 708, the method 700 may include determining whether the identified timing interval for the RAR 402b (as shown in FIG. 4) overlaps with at least one of the one or more timing intervals for the MUSIM operations based on a comparison of the MUSIM gap configuration information with the identified timing interval for the RAR. Moreover, upon determining that the timing interval for the RAR overlaps with at least one of the one or more timing intervals for the MUSIM operations, the method 700 may include skipping the MUSIM operations to wait for the RAR from the network, at step 710. However, upon determining that the timing interval for the RAR does not overlaps with at least one of the one or more timing intervals for the MUSIM operations, the method 700 may include performing the MUSIM operation and RAR operation based on the received MUSIM gap configuration and the identified timing interval for RAR, as indicated by step 712.

The above embodiment may be captured according to the below changes in the specification:
5.1.4 Random Access Response reception

Once the Random Access Preamble is transmitted and regardless of the possible occurrence of a measurement gap or a MUSIM-gap, the MAC entity shall:
1>if the contention-free Random Access Preamble for beam failure recovery request was transmitted by the MAC entity:
2>if the contention-free Random Access Preamble for beam failure recovery request was transmitted on a non-terrestrial network:
3>start the ra-Response Window configured in BeamFailureRecoveryConfig at the PDCCH occasion as specified in TS 38.213 [6].
2>else:
3>start the ra-Response Window configured in BeamFailureRecoveryConfig at the first PDCCH occasion as specified in TS 38.213 [6] from the end of the Random Access Preamble transmission.
2>monitor for a PDCCH transmission on the search space indicated by recovery-SearchSpaceId of the SpCell identified by the C-RNTI while ra-Response Window is running.
1>else:
2>if the Random Access Preamble was transmitted on a non-terrestrial network:
3>start the ra-Response Window configured in RACH-ConfigCommon at the PDCCH occasion as specified in TS 38.213 [6].
2>else:
3>start the ra-Response Window configured in RACH-ConfigCommon at the first PDCCH occasion as specified in TS 38.213 [6] from the end of the Random Access Preamble transmission.
5.1.4a MSGB reception and contention resolution for 2-step RA type

Once the MSGA preamble is transmitted, regardless of the possible occurrence of a measurement gap or a MUSIM-gap, the MAC entity shall:
1>start the msgB-Response Window at the PDCCH occasion as specified in TS 38.213 [6], clause 8.2A;

FIG. 8 is a diagram illustrating the configuration of a device 800 for the UE 102 in a wireless communication system, according to embodiments of the present disclosure. The device 800 may be the UE. Further, the methods disclosed above may be implemented by the UE 102 using the device 800, according to an embodiment. Hereinafter, it is understood that terms including “unit” or “module” at the end may refer to the unit for processing at least one function or operation and may be implemented in hardware, software, or a combination of hardware and software.

Referring to FIG. 8, the device 800 may include at least one processor 802 (may also be referred to herein in the singular “the processor 802”), a communication unit 806 (e.g., communicator or communication interface or a transceiver), and/or a memory unit 804 (e.g., storage). The communication unit 804 may perform functions for transmitting and/or receiving signals via a wireless channel.

As an example, the processor 802 may be a single processing unit or a number of units, all of which could include multiple computing units. The processor 802 may be implemented as one or more microprocessors, microcomputers, microcontrollers, digital signal processors, central processing units, state machines, logic circuitries, and/ or any devices that manipulate signals based on operational instructions. Among other capabilities, the processor 802 is configured to fetch and execute computer-readable instructions and data stored in the memory 804. The processor 802 may include one or a plurality of processors. At this time, one or a plurality of processors 802 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The memory unit 804 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes. According to embodiments, the memory unit 804 may store the first list and the second list.

Embodiments disclosed herein may be implemented using processing circuitry. For example, according to embodiments, operations described herein as being performed by the UE 102, the at least one processor 802, and/or the communication unit 806 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. For instance, embodiments disclosed herein may be implemented using at least one software program running on at least one hardware device and performing network management functions to control the elements.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

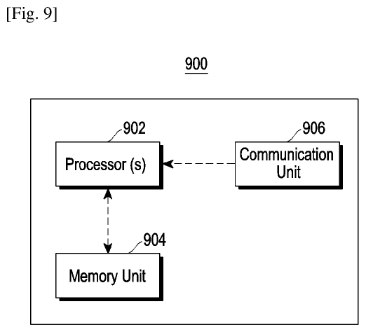

FIG. 9 is a diagram illustrating the configuration of a device 900 for the network 104 in a wireless communication system, according to embodiments of the present disclosure. The device 900 may be the base station. The configuration of the device 900 may be similar to the configuration of the device 800, accordingly the similar components have been provided with corresponding reference numerals and a description of the same has been omitted for the sake of brevity.

Thus, the present disclosure enable effective handling of DRX adaptation, UL transmission adaptation, and RA transmission adaptation during MUSIM operations, which wasting resources and power.

While specific language has been used to describe the disclosure, any limitations arising on account of the same are not intended. As would be apparent to a person in the art, various working modifications may be made to the method in order to implement the inventive concepts as taught herein.

The drawings and the forgoing description give examples of embodiments. Those skilled in the art will appreciate that one or more of the described elements may well be combined into a single functional element. Alternatively, certain elements may be split into multiple functional elements. Elements from one example may be added to another example. For example, orders of processes described herein may be changed and are not limited to the manner described herein.

Moreover, the actions (e.g., operations) of any flow diagram need not be implemented in the order shown; nor do all of the acts necessarily need to be performed. For example, actions or operations illustrated as being performed serially in two consecutive blocks may actually be performed concurrently, simultaneously, contemporaneously, or in some cases be performed in reverse order. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to challenges have been described above with regard to specific examples. However, the benefits, advantages, solutions to challenges, and any component(s) that may cause any benefit, advantage, or solution to occur or become more pronounced are not to be construed as a critical, required, or essential feature or component of any or all the claims.

1. A method performed by a user equipment (UE) in a wireless communication system supporting multiple subscriber identity module (MUSIM) operations, the method comprising:
receiving, from a base station, discontinuous reception (DRX) configuration information, configuration information on downlink control information (DCI) with a cyclic redundancy check (CRC) scrambled by power saving-radio network temporary identifier (PS-RNTI) (DCP) occasion, and MUSIM gap configuration information, wherein the DRX configuration information includes DRX cycle information, the configuration information on the DCP occasion includes one or more timing intervals for wakeup indication, and the MUSIM gap configuration information includes one or more timing intervals for the MUSIM operations;
determining whether the one or more timing intervals for wakeup indication associated with a current DRX cycle overlaps with at least one of the one or more timing intervals for the MUSIM operations based on the DRX configuration information, the configuration information on the DCP occasion, and the MUSIM gap configuration information; and
in case that the one or more timing intervals for wakeup indication associated with the current DRX cycle overlap with at least one of the one or more timing intervals for the MUSIM operations, starting a DRX-ON duration timer after the at least one of the one or more timing intervals for the MUSIM operations has lapsed.

2. The method of claim 1, wherein the DRX configuration information further includes at least one of a DRX-slot offset timing interval, a DRX-on duration timer, a DRX-inactivity timer, or a DRX-cycle interval.

3. The method of claim 1, further comprising:
in case that at least one timing interval from the one or more time intervals for wakeup indication does not overlap with at least one of the one or more timing intervals for the MUSIM operations, determining whether there is a wakeup indication during the at least one timing interval for wakeup indication; and
in case that there is no wakeup indication during the at least one timing interval for wakeup indication, skipping an upcoming DRX-ON duration timer based on the DRX configuration information.

4. The method of claim 3, further comprising:
in case that there is a wakeup indication during the at least one timing interval for wakeup indication, starting the DRX-ON duration timer after the at least one of the one or more timing intervals for the MUSIM operations has lapsed.

5. The method of claim 2, wherein starting the DRX-ON duration timer after the at least one of the one or more timing intervals for the MUSIM operations has lapsed comprises:
identifying the DRX-slot offset timing interval and a subframe where a DRX ON period starts from the DRX configuration information; and
starting the DRX-ON duration timer after a lapse of the DRX-slot offset timing interval in the subframe.

6. A method performed by a user equipment (UE) in a wireless communication system supporting multiple subscriber identity module (MUSIM) operations, the method comprising:
receiving, from a base station, MUSIM gap configuration information including at least one or more timing intervals for the MUSIM operations;
generating a trigger message for performing uplink (UL) transmission, wherein the trigger message includes information indicating at least timing for the UL transmission;
determining whether the timing for the UL transmission overlaps with at least one of the one or more timing intervals for the MUSIM operations based on the MUSIM gap configuration information and the information included in the trigger message; and
in case that the timing for the UL transmission overlaps with at least one of the one or more timing intervals for the MUSIM operations, skipping the UL transmission for at least the one or more timing intervals for the MUSIM operations.

7. The method of claim 6, further comprising:
determining, based on the MUSIM gap configuration information, whether the UL transmission is allowed during the one or more timing intervals for the MUSIM operations; and
in case that the UL transmission is allowed during the one or more timing intervals for the MUSIM operations, performing the UL transmission during the one or more timing intervals for the MUSIM operations.

8. The method of claim 6, wherein the UL transmission corresponds to transmission of at least one of a scheduling request (SR), a hybrid automatic repeat request (HARQ) feedback, or channel state information (CSI).

9. The method of claim 6, further comprising:
identifying a priority of the MUSIM operations based on the MUSIM gap configuration information;
identifying a priority of the UL transmission based on the information included in the trigger message;
comparing the priority of the MUSIM operations with the priority of the UL transmission; and
determining whether to perform the MUSIM operations or the UL transmission based on said comparison.

10. A method performed by a user equipment (UE) in a wireless communication system supporting multiple subscriber identity module (MUSIM) operations, the method comprising:
receiving, from a base station, MUSIM gap configuration information including at least one or more timing intervals for the MUSIM operations;
transmitting, to the base station, a message for performing random access (RA) operation;
identifying a timing interval for random access response (RAR) based on the transmitted message for performing the RA operation;
determining whether the identified timing interval for the RAR overlaps with at least one of the one or more timing intervals for the MUSIM operations based on a comparison of the MUSIM gap configuration information with the identified timing interval for the RAR; and
in case that the timing interval for the RAR overlaps with at least one of the one or more timing intervals for the MUSIM operations, skipping the MUSIM operations to wait for the RAR from the base station.

11. A user equipment (UE) in a wireless communication system supporting multiple subscriber identity module (MUSIM) operations, the UE comprising:
a transceiver, and
at least one processor configured to:
receive, from a base station, discontinuous reception (DRX) configuration information, configuration information on downlink control information (DCI) with a cyclic redundancy check (CRC) scrambled by power saving-radio network temporary identifier (PS-RNTI) (DCP) occasion, and MUSIM gap configuration information, wherein the DRX configuration information includes DRX cycle information, the configuration information on the DCP occasion includes one or more timing intervals for wakeup indication, and the MUSIM gap configuration information includes one or more timing intervals for the MUSIM operations;
determine whether the one or more timing intervals for wakeup indication associated with a current DRX cycle overlaps with at least one of the one or more timing intervals for the MUSIM operations based on the DRX configuration information, the configuration information on the DCP occasion, and the MUSIM gap configuration information; and
in case that the one or more timing intervals for wakeup indication associated with the current DRX cycle overlap with at least one of the one or more timing intervals for the MUSIM operations, start a DRX-ON duration timer after the at least one of the one or more timing intervals for the MUSIM operations has lapsed.

12. The UE of claim 11, wherein the DRX configuration information further includes at least one of a DRX-slot offset timing interval, a DRX-on duration timer, a DRX-inactivity timer, or a DRX-cycle interval.

13. The UE of claim 11, wherein the at least one processor is further configured to:
upon determining that at least one timing interval from the one or more time intervals for wakeup indication does not overlap with at least one of the one or more timing intervals for the MUSIM operations, determine whether there is a wakeup indication during the at least one timing interval for wakeup indication, and
skip an upcoming DRX-ON duration timer based on the DRX configuration information upon determining that there is no wakeup indication during the at least one timing interval for wakeup indication.

14. The UE of claim 13, wherein the at least one processor is further configured to:
in case that there is a wakeup indication during the at least one timing interval for wakeup indication, start the DRX-ON duration timer after the at least one of the one or more timing intervals for the MUSIM operations has lapsed.

15. The UE of claim 12, wherein the at least one processor is further configured to:
identify the DRX-slot offset timing interval and a subframe where a DRX ON period starts from the DRX configuration information; and
start the DRX-ON duration timer after a lapse of the DRX-slot offset timing interval in the subframe.
